(19) United States
(12) Patent Application Publication
(10) Pub. No.: US 2008/0103984 A1
(43) Pub. Date: May 1, 2008

(54) System, Method, and Computer-Readable Medium for Mobile Payment Authentication and Authorization

(75) Inventors: Howon Choe, Richardson, TX (US); Yeonsook Choe, Richardson, TX (US); Min Park, Garland, TX (US)

Correspondence Address: HAYNES AND BOONE, LLP, 901 Main Street, Suite 3100, Dallas, TX, 75202, US

(73) Assignee: MOBILEKASH, INC., Farmers Branch, TX (US)

(21) Appl. No.: 11/855,856

(22) Filed: Sep. 14, 2007

Related U.S. Application Data
(60) Provisional application No. 60/863,431, filed on Oct. 30, 2006.

(51) Int. Cl. G06Q 30/00; G06F 17/30; H04L 9/32

(52) U.S. Cl. 705/76; 705/16; 705/26

(57) ABSTRACT

A system, method, and computer-readable medium for user authentication and mobile payment authorization are provided. A user operating a mobile terminal may submit a product for purchase at a point-of-sale and submit the user's phone number and personal identification number thereto. An authentication and authorization process is then performed to authenticate the user and authorize the purchase. Upon authentication and authorization, a one-time-password is transmitted to the point-of-sale and the user's mobile terminal. The user provides the one-time-password as input to the point-of-sale which compares the one-time-password provided by Mobile Payment System with the one-time-password provided by the user to determine whether to approve or deny the purchase. Multiple users each having different authorization levels and purchase limits may be associated with a common account, and each user may have a distinct identifier used to authenticate the particular user of the account.

### RELATED APPLICATION DATA

This patent application claims the benefit of provisional U.S. Patent Application Ser. No. 60/863,431, filed Oct. 30, 2006, which is hereby incorporated by reference.

### BACKGROUND

The advent of mobile communication networks has opened many new mechanisms for cashless payments for products and services using personal wireless devices. Products purchased with mobile payments have become diverse, ranging from mobile contents to vending machine items. Equally diverse are the mobile payment methods owing to the relatively new payment system that can be implemented in many different ways. One common step in these methods of mobile payment is the authentication and authorization in which all users who wishes to make a payment via a mobile device must be authenticated such that the merchant will receive the authorization to proceed with the sale.

In the context of this specification, the term “subscriber” means the owner of the line or the payer of the bills. The term “user” means the user of a mobile phone, who may or may not be the owner of the line who pays the bills, who is making a purchase.

In existing Mobile Payment Systems, the user makes a purchase at the point-of-sale (POS) terminal or website, and the POS sends a message including such information as the mobile phone number of the user to the mobile payment system for authentication. The payment system then verifies the mobile account subscriber and proceeds to authorize the purchase. A deficiency of this method is that all users with mobile phones are treated as independent account subscribers, and such mechanisms allow account users (other mobile phone users under the main subscriber account) equal access to purchasing as the account subscriber. For this reason, contemporary Mobile Payment Systems do not provide any ability to control the purchase of products and services for different levels or types of users, such as children whose parents may want to control their mobile purchase. Prepaid types of billing have provided limited opportunities for customizing the product type or service and limiting the billing period amount.

Therefore, what is needed is a mechanism that overcomes the described problems and limitations.

### BRIEF DESCRIPTION OF THE DRAWINGS

Aspects of the present disclosure are best understood from the following detailed description when read with the accompanying figures, in which:

FIG. 1 is a diagrammatic representation of a network system in which mobile purchase and authorization mechanism implemented in accordance with an embodiment may be implemented;

FIG. 2 is a diagrammatic representation of an exemplary Mobile Payment System that may be configured to facilitate user authentication and purchase authorization in accordance with embodiments disclosed herein;

FIG. 3A is a diagrammatic representation of a user database depicted in FIG. 1 that facilitates user authentication and product purchase authorization implemented in accordance with an embodiment;

FIG. 3B is a diagrammatic representation of a product database depicted in FIG. 1 that facilitates user authentication and product purchase authorization implemented in accordance with an embodiment;

FIG. 4 is a diagrammatic representation of a signaling flow that facilitates authorization and mobile payment of a good or service in accordance with an embodiment;

FIG. 5 is a flowchart depicting processing of a merchant point-of-sale processing routine that facilitates user authentication and product purchase authentication in accordance with an embodiment;

FIG. 6 is a flowchart depicting processing of a Mobile Payment System processing routine that facilitates user authentication and product purchase authorization in accordance with an embodiment; and

FIG. 7 is a flowchart that depicts processing of a mobile purchase authorization subroutine implemented in accordance with an embodiment.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

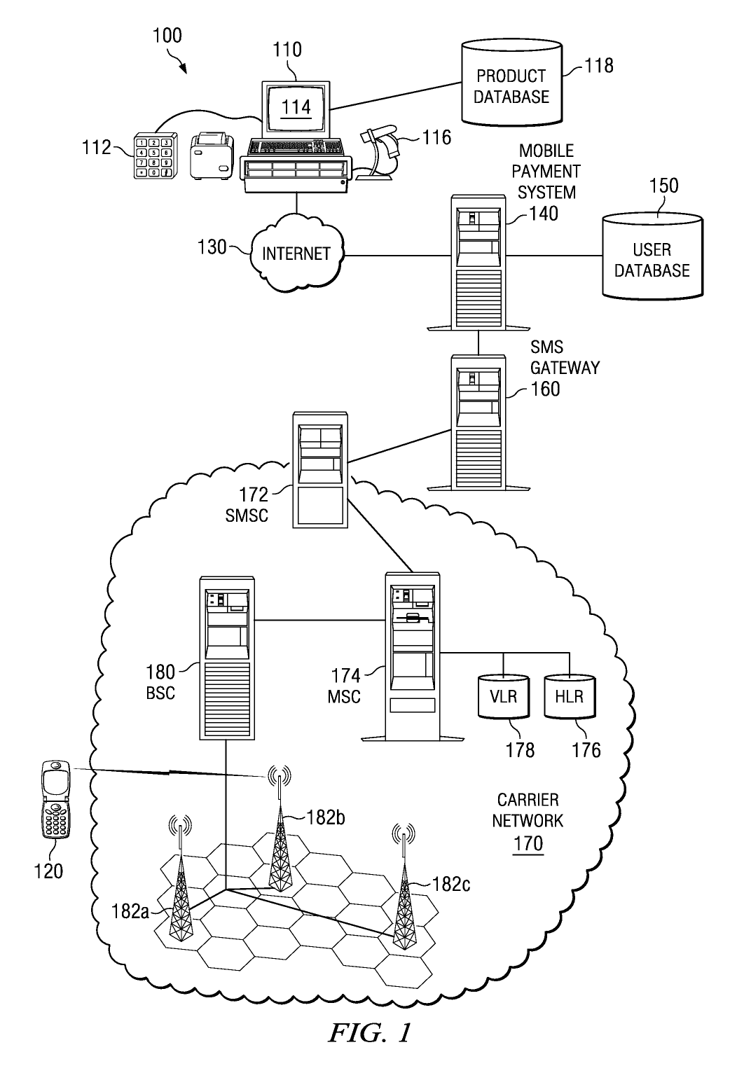

FIG. 1 is a diagrammatic representation of a network system 100 in which user authorization and mobile purchase authorization mechanisms implemented in accordance with an embodiment may be implemented. System 100 includes a merchant point-of-sale terminal, referred herein simply as POS 110. POS 110 may be implemented in a combination of hardware and software and may include a keypad 112 for user-supplied input, a display device 114 for visual output of transaction information including transaction status, and a product scanner 116, such as a laser scanner or CCD reader adapted to read product barcodes. In accordance with an embodiment, a product or service purchase may be made at POS 110 by a user with a mobile terminal 120, although in other embodiments, product purchases may be made from a web page or other interface.

POS 110 is communicatively coupled with a Mobile Payment System 140, e.g., via a network such as the Internet 130. Mobile Payment System 140 may be implemented as a data processing system, such as a server, and is adapted to process mobile-originated purchases. To this end, Mobile Payment System 140 may include or interface with a user database 150 that maintains records of users that are registered to make purchases via the mobile payment system. User records of database 150 may specify various account attributes, such as a user names, phone numbers, authorization levels, purchase limits, and the like.

Mobile Payment System 140 is communicatively interfaced with a short message service (SMS) provider, such as a wireless carrier network 170. In the illustrative example, Mobile Payment System 140 is interfaced with carrier network 170 via an SMS gateway 160. SMS gateway 160 may be hosted by carrier network 170, or alternatively by an independent or third party SMS provider. SMS gateway 160 may be communicatively interfaced with an SMS Center (SMSC) 172 which may operate as a store-and-forward platform. SMSC 172 may interface with a mobile switching system, e.g., a mobile services switching center (MSC) 174. The mobile switching system may include or interface with a Home Location Register (HLR) 176, and a Visitor Location Register (VLR) 178. MSCs carry out switching functions and manage the communications between mobile phones and the Public Switched Telephone Network (PSTN). HLR 176 comprises the central database that contains details of each mobile phone user that is authorized to use the cellular core network. VLR 178 comprises a database which stores information about all the mobiles terminals that are currently serviced by the associated MSC. VLR 178 stores various information regarding the mobile terminals, such as the current location area identity that specifies a particular base station controller (BSC) that currently services the mobile phone. MSC 174 interfaces with a radio access network comprising a base station subsystem (BSS). In the illustrative example, the radio access network comprises a BSC 180 and various base transceiver stations (BTSs) 182a-182c operated under the control of BSC 180. BSC 180 manages and directs allocation of radio channels, receives measurements from the mobile phones, and controls handovers between BTSs among other functions. BTSs 182a-182c comprise one or more respective antenna and equipment for transmitting and receiving radio signals, and functions for encrypting and decrypting communications with BSC 180. BTSs 182a-182c provide for communications with mobile terminal 120 over an air-interface.

FIG. 1 is intended as an example network system, and not as an architectural limitation, in which embodiments disclosed herein may be implemented. While the descriptions of a carrier network architecture, and nomenclature related thereto, for transmission of an SMS message are made with reference to the Global System for Mobile (GSM) Communications, it is understood that this is done so for illustrative purposes only and that the network architecture on which embodiments disclosed herein may be applied is not limited to GSM but may be equivalently implemented on any variety of mobile communications systems. Network and device examples provided herein are illustrative only and implementations of the disclosed embodiments are not limited to any particular network, network-compliant device, or network communication formats or protocols. Furthermore, the description and illustration of SMS messaging as a transmission medium for communications between Mobile Payment System 140 and mobile terminal 120 is illustrative only, and various other messaging systems may be substituted therefore. For example, messaging transmissions from Mobile Payment System 140 to mobile terminal 120 may be made via Unstructured Supplementary Service Data (USSD) via a signaling channel or another suitable messaging mechanism.

In accordance with embodiments disclosed herein, a user operating mobile terminal 120 may submit a product for purchase at POS 110. A product ID is obtained by POS 110, e.g., via product scanner 116. A product price may additionally be obtained by POS, e.g., via a product database 118 included or interfaced with POS 110. Product database 118 maintains product “descriptions” which may include product classification (e.g., “adult”, “child” or other product classifications), product ratings, price, or other descriptive information. The product descriptions may be associated with respective product identifiers (PIDs) additionally stored in product database 118. Product identifiers may comprise UPCs obtained from barcodes or other product identifiers. The user may then enter the user's phone number and personal identification number (PIN) at POS 110, e.g., via keypad 112. An authentication and authorization process is then performed to authenticate the user and authorize the transaction. In an embodiment, POS 110 generates an encrypted message that is transmitted to Mobile Payment System 140 for user authentication and purchase authorization. The encrypted message includes the user's mobile phone number and PIN, as well as the product ID, e.g., UPC code of the product to be purchased. Additionally, the encrypted message includes product description data including but not limited to product classification. The encrypted message may include a merchant ID that comprises an identifier uniquely assigned to the merchant hosting POS 110. On receipt of the encrypted message, Mobile Payment System 140 may authenticate the user, e.g., via the user's phone number and PIN. If the user is successfully authenticated, the purchase request may be evaluated to determine if the user is authorized to purchase the product. For example, a classification of the product may be used to determine if the user authorization level is sufficient for purchasing the product. Furthermore, the user's purchase limit may be evaluated to determine if the user has a sufficient purchase limit for the product. If the user is authenticated and authorized successfully, a one-time-password (OTP) is generated by Mobile Payment System 140. The OTP may then be encrypted and transmitted to POS 110. An encryption key may also be transmitted to POS 110 for decrypting the OTP. On receipt of the encrypted message and the key, POS 110 may decrypt the message to obtain the OTP.

Additionally, an SMS request may be transmitted from Mobile Payment System 140 to an SMS provider. The SMS request may include the user's mobile phone number and the OTP. The SMS provider, in turn, generates an SMS message that is addressed to the user's mobile phone number and that includes the OTP. An SMS message including the OTP is then transmitted from the SMS service provider to the user's mobile phone. On receipt of the SMS message, the user may read the OTP and provide the OTP as input to POS 110, e.g., at keypad 112. POS 110 may then compare the OTP provided by Mobile Payment System 140 with the OTP provided by the user. If the OTPs match, the purchase may be completed, and a receipt for the product may be issued. If the OTPs do not match, the purchase may be denied by POS 110.

In accordance with a particular embodiment, multiple users may be associated with a common account. Each user may have a distinct identifier, such as a personal identification number, that is used to authenticate a particular user of the account. The personal identification number may be used in conjunction with a mobile phone number associated with the particular account user. Each of the plurality of users of a common account may have different authorization levels assigned thereto. For instance, an adult that is responsible for the account subscription may have an adult authorization designation, while children or other users of the account may have different authorization levels. Assignment of different authorization levels to users of a common account facilitates purchase restrictions, e.g., age-based product restrictions, as well as account spending limits that may be different for different account users.

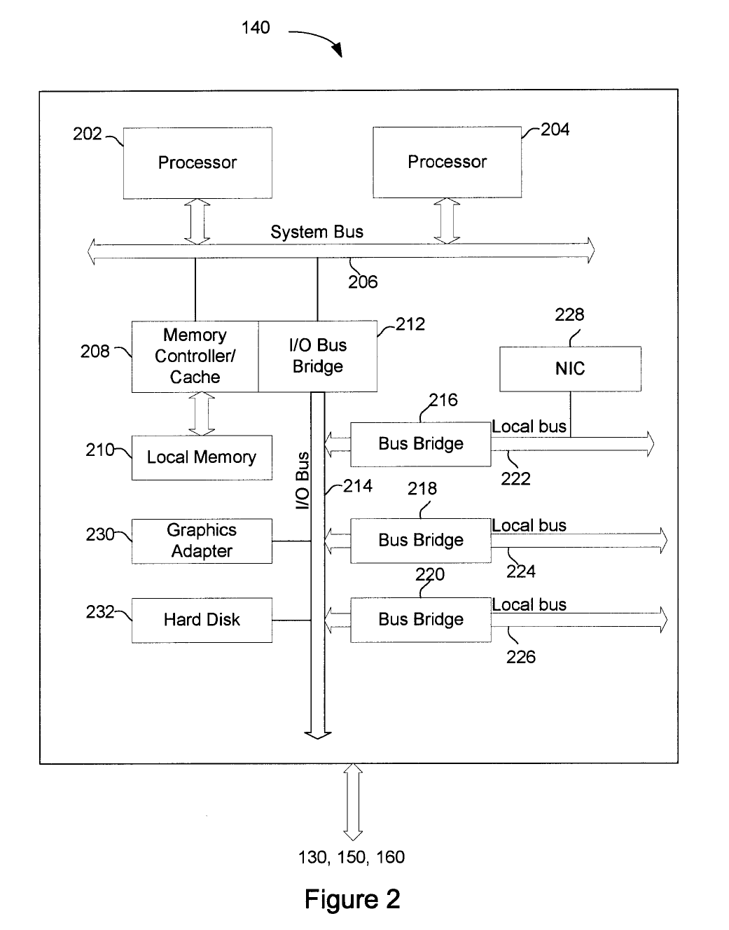

FIG. 2 is a diagrammatic representation of an exemplary Mobile Payment System 140 that may be configured to facilitate user authentication and purchase authorization in accordance with embodiments disclosed herein.

Mobile Payment System 140 may be a symmetric multiprocessor (SMP) system that includes a plurality of processors 202 and 204 connected to a system bus 206 although other single-processor or multi-processor configurations may be suitably substituted therefor. A memory controller/cache 208 that provides an interface to local memory 210 may also be connected with system bus 206. An I/O bus bridge 212 may connect with system bus 206 and provide an interface to an I/O bus 214. Memory controller/cache 208 and I/O bus bridge 212 may be integrated into a common component.

A bus bridge 216, such as a Peripheral Component Interconnect (PCI) bus bridge, may connect with I/O bus 214 and provide an interface to a local bus 222, such as a PCI local bus. Communication links to other network nodes of system 100 in FIG. 1 may be provided through a network interface card (NIC) 228 connected to local bus 222 through add-in connectors. Additional bus bridges 218 and 220 may provide interfaces for additional local buses 224 and 226 from which peripheral or expansion devices may be supported. A graphics adapter 230 and hard disk 232 may also be connected to I/O bus 214 as depicted.

Those of ordinary skill in the art will appreciate that the hardware depicted in FIG. 2 may vary. The depicted example is not intended to imply architectural limitations with respect to implementations of the present disclosure.

A user may register with Mobile Payment System 140 and have account characteristics assigned thereto. In an embodiment, the user's name, mobile phone number and a personal identification number (PIN) are stored in a record of user database 150. The user may additionally specify an authorization level and purchase limit that is assigned to the user. Alternatively, a Mobile Payment System administrator may assign an authorization level for a user, e.g., based on the user's age. Other users may be assigned to the account and may have different authorization levels and purchase limits assigned thereto.

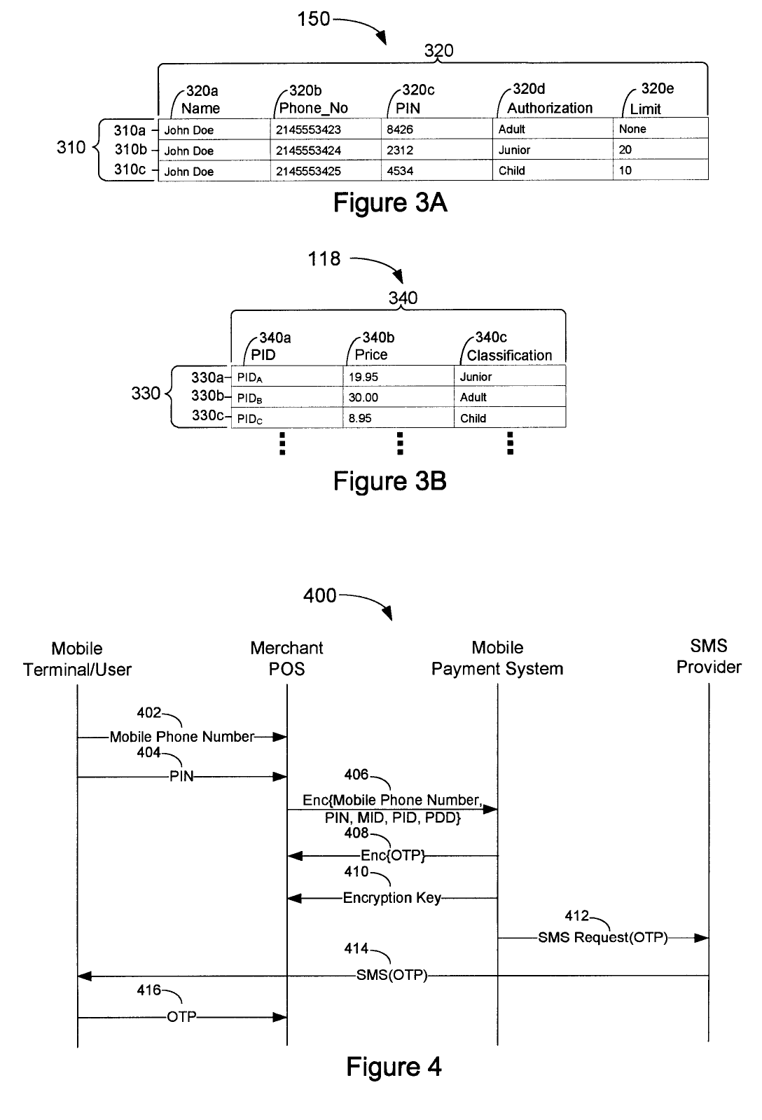

FIG. 3A is a diagrammatic representation of a user database 150 depicted in FIG. 1 that facilitates user authentication and product purchase authorization implemented in accordance with an embodiment. In the illustrative example, user database 150 comprises a table although other data structures may suitably be substituted therefor.

User database 150 comprises a plurality of records 310a-310c (collectively referred to as records 310) and fields 320a-320e (collectively referred to as fields 320). Database 150 may be stored on a disk drive, fetched therefrom by a processor of Mobile Payment System 140, and processed thereby.

In the present example, fields 320a-320e have labels of “Name”, “Phone_No”, “PIN”, “Authorization”, and “Limit”. Name field 320a stores user names that are registered for mobile product purchases via Mobile Payment System 140. In the present example, each of records 310a-310c is allocated for a user named “John Doe”. Phone_No field 320b stores a mobile phone number assigned to the user of a corresponding record. Thus, in the illustrative example, the user “John Doe” has three mobile phones that are registered to make mobile phone facilitated product purchases. PIN field 320c stores user PINs associated with a mobile phone of a respective record. In the illustrative example, PINs of “8426”, “2312”, and “4534” are assigned to mobile phones with numbers specified in field 320b of a corresponding record. Accordingly, different users sharing a common account may be authenticated with a respective mobile phone number and PIN pair specified by fields 320b and 320c. Authorization field 320d stores an authorization level that is assigned to the user's mobile phone of a corresponding record. In the illustrative example, an authorization level may be assigned “Adult”, “Junior”, or “Child”. In the present example, the mobile phone having a phone number of 214-555-3423 is allocated an authorization level of “Adult”, the mobile phone having a phone number of 214-555-3424 is allocated an authorization level of “Junior”, and the mobile phone having a phone number of 214-555-3425 is allocated an authorization level of “Child”. The authorization level facilitates purchase of products that may be age-restricted products. For example, alcohol or tobacco products may be registered as adult-only products and may not be legally acquired by non-adults, e.g., persons of age 21 years or older. In accordance with an embodiment, when an attempt is made to purchase a product, a classification level of the product may be compared with the user's authorization level to determine if the purchase should be granted or denied. Limit field 320e may specify a monetary limit of product purchases that may be made with an associated phone. For example, the phone having the phone number 2145553423 has a limit of “None” indicating that no purchase limit is assigned to the phone. The phone having the phone number 2145553424 has a limit of “20” dollars, and the phone having the phone number 2145553425 has a limit of “10” dollars. The purchase limit specified by Limit field 320e may comprise a monthly purchase limit, a daily purchase limit, or another suitable interval-based purchase limit. When a purchase is successfully made, the limit specified for the mobile phone from which the purchase was made may be deducted by the purchase amount.

FIG. 3B is a diagrammatic representation of product database 118 depicted in FIG. 1 that facilitates user authentication and product purchase authorization implemented in accordance with an embodiment.

Product database 118 comprises a plurality of records 330a-330c (collectively referred to as records 330) and fields 340a-340c (collectively referred to as fields 340). Database 118 may be stored on a memory or other storage device, fetched therefrom by a processor of POS terminal 110, and processed thereby.

In the present example, fields 340a-340c have labels of “PID”, “Price”, and “Classification”. PID field 340a stores product identifiers assigned to merchant products. In the present example, PIDs of records 330a-330c are illustratively designated PID_{A}-PID_{C}. Price field 340b stores a product price assigned to a product specified in PID field 340a of a corresponding record. Thus, in the illustrative example, the products having PIDs of “PID_{A}”-“PID_{C}” have respective prices of “19.95”, “30.00”, and “8.95”. Classification field 340c stores product classifications associated with products specified in PID field 340a of a corresponding record. In the illustrative example, products having product IDs of “PID_{A}”, “PID_{B}”, and “PID_{C}” are assigned respective product classifications of “Junior”, “Adult”, and “Child”. Product classifications specified by field 340c associated with product IDs specified in field 340a facilitate evaluation of a user's authorization for purchasing a product in accordance with disclosed embodiments.

FIG. 4 is a diagrammatic representation of a signaling flow that facilitates use authentication and mobile purchase authorization of a good or service in accordance with an embodiment. A good or service (herein referred to as a product) to be purchased is scanned or otherwise subjected to a transaction, and a produce identity (PID) associated therewith is obtained by the merchant point-of-sale (POS) terminal. The user then enters the mobile phone number, e.g., through an interface of the POS terminal (step 402), as well as a PIN or other security code (step 404). The merchant's payment system generates an encrypted message that contains the user's mobile phone number, PIN, a merchant ID (MID) associated with the merchant, and the PID. The encrypted message may also include the product price, e.g., as obtained from product database 118. The product price may be included in product description data (PDD) that may specify the product, a rating or classification of the product, or other descriptive product data. The PDD including the product price may be obtained by POS terminal 110 from product database 118. The encrypted message is sent to the Mobile Payment System via the merchant's network (step 406). The Mobile Payment System performs decryption on the message received, and obtains the user's mobile phone number, PIN, MID, and PID and proceeds authentication processing using the user's mobile phone number and PIN. During authentication, the Mobile Payment System may first authenticate the user, e.g., by querying user database 150 with the phone number and PIN. If the user is authenticated, the Mobile Payment System may then authorize the user's product purchase based on the authorization level and the purchase limit assigned to the user's mobile ID and PIN as predefined by the user. For example, the Mobile Payment System may compare a classification of the PID, e.g., child, junior, adult, and the user authorization level. Moreover, the Mobile Payment System may compare the product price with a transaction limit assigned to the user. If the purchase is not authorized, e.g., if the user credentials such as the phone number or PIN do not match an authenticate user, if the merchant/product level or the price of the product does not meet the authorization level or the purchase limit of the user, the purchase is denied and the merchant is notified accordingly. Purchase denial may then be displayed at the merchant POS. In the illustrative example, assume the merchant/product level and the price of the product does meet the authorization level requirement and the purchase limit of the user. The Mobile Payment System generates a One-Time-Password (OTP), encrypts the OTP, and transmits the encrypted OTP (illustratively designated Enc{OTP}) to the merchant POS (step 408). The Mobile Payment System may transmit an encryption key to the merchant POS for decrypting the OTP (step 410). The Mobile Payment System also sends the OTP to the mobile terminal. For example, the OTP may be sent in an SMS request to an SMS provider (step 412), which in turn generates an SMS message including the OTP and transmits the SMS message to the mobile terminal (step 414). The merchant's POS decrypts the OTP with the received key and obtains the OTP supplied by the Mobile Payment System therefrom. The user reads the OTP from the SMS message and enters the received OTP into the merchant's website or POS terminal (step 416), e.g., via keypad 112. The merchant's POS then compares the OTP received from the Mobile Payment System with the OTP provided by the user. If the two OTPs match, the merchant issues a receipt and delivers the product to the user. If the two OTPs do not match, the merchant payment system denies the purchase request and prints a message on the merchant website or POS display. A purchase confirmation may be transmitted from the POS to the Mobile Payment System such that the price of the accepted purchase is deducted from the limit amount of the user and the resulting amount is set as the new limit for the user. The billing center, which may be independent from the mobile network, collects the billing data and the subscriber pays for the purchase.

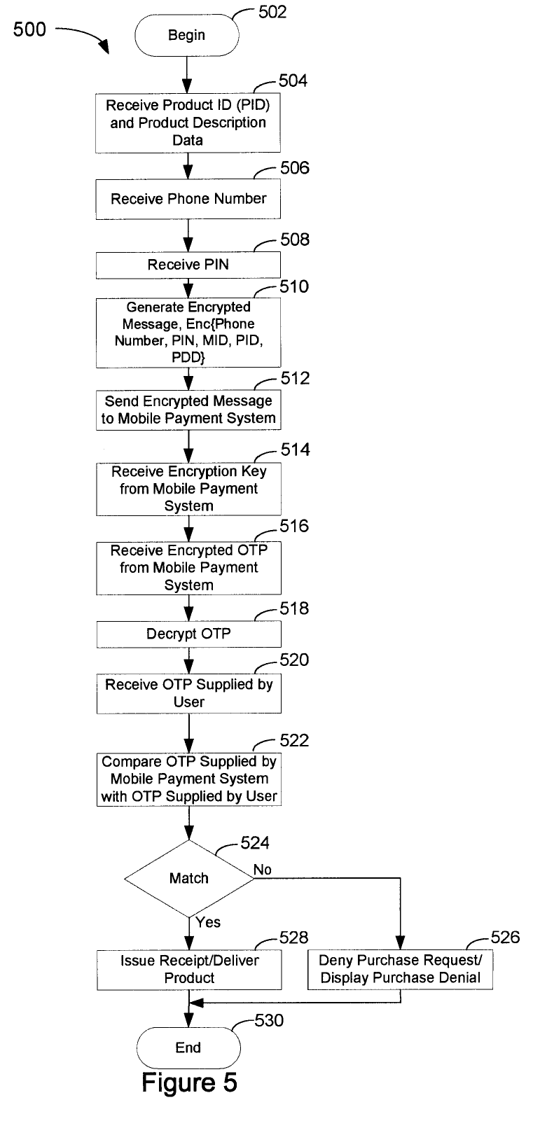

FIG. 5 is a flowchart 500 depicting processing of a merchant point-of-sale processing routine that facilitates user authentication and product purchase authorization in accordance with an embodiment. The processing steps of FIG. 5 may be implemented as computer-executable instructions executable by a processing system, such as merchant POS 110 depicted in FIG. 1.

The routine is invoked (step 502), and a product ID to be purchased along with product description data (PDD) is received (step 504). The product ID may comprise, for example, a universal product code (UPC). The PDD may include the product classification as well as the product price. The PDD may be obtained by interrogating product database 118 with the PID obtained from the product scanner. The point-of-sale terminal then receives the user mobile phone number (step 506) and personal identification number (PIN) (step 508) as supplied by the user. The point-of-sale terminal then generates an encrypted message containing the phone number, PIN, merchant ID (MID), product ID, and PDD (step 510). The PDD included in the encrypted message may include the product price as well as the product classification. Merchant IDs may, for example, comprise unique identifier each respectively assigned to a merchant that participates in the disclosed mobile payment system. The encrypted message is then transmitted to the Mobile Payment System (step 512). The merchant POS then awaits for a reply from the Mobile Payment System. If the purchase is denied, a denial response will be received at the merchant POS, and an indication of the denial may be displayed to the user. Assuming the purchase is not denied, the merchant POS receives an encryption key from the Mobile Payment System (step 514) as well as an OTP in an encrypted form (step 516). The encrypted OTP may then be decrypted (step 518). An OTP is received by the user via SMS or another messaging service, and the OTP is supplied to the merchant POS by the user. On receipt of the OTP by the merchant POS from the user (step 520), the merchant POS compares the user-supplied OTP with the OTP received from the Mobile Payment System (step 522). An evaluation may then be made to determine if the user-supplied OTP matches the OTP supplied by the Mobile Payment System (step 524). If the OTPs do not match, the purchase request is denied, and a purchase denial message may be displayed by the POS (step 526). The POS processing routine cycle may then end (step 530). If the OTPs are determined to match at step 524, the product purchase transaction may be successfully completed, and a receipt may be issued by the merchant POS (step 528). The POS processing routine cycle may then end according to step 530.

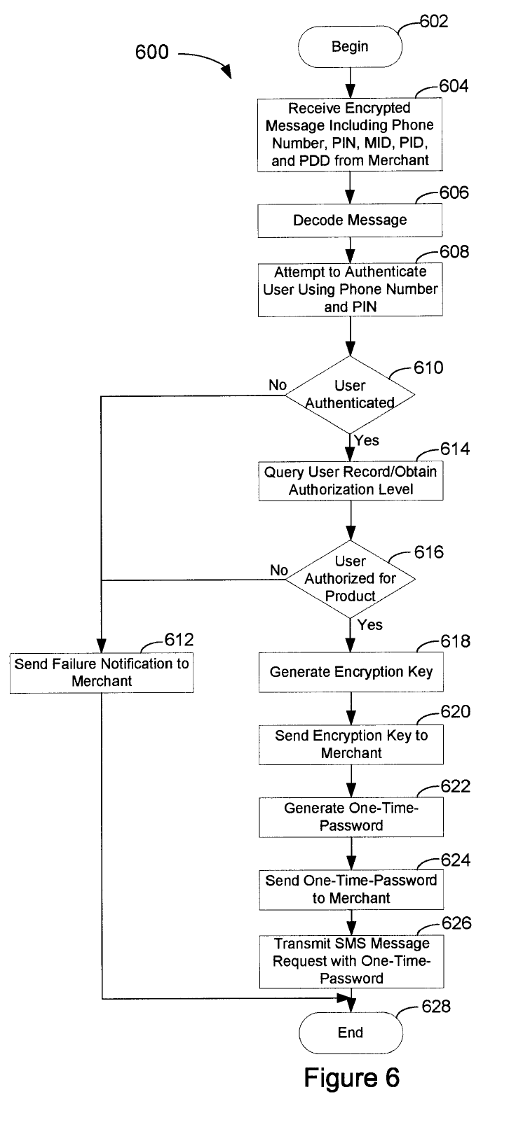

FIG. 6 is a flowchart 600 depicting processing of a Mobile Payment System processing routine that facilitates user authentication and product purchase authorization in accordance with an embodiment. The processing steps of FIG. 6 may be implemented as computer-executable instructions executable by a processing system, such as Mobile Payment System 140 depicted in FIGS. 1 and 2.

The routine is invoked (step 602), and the Mobile Payment System receives an encrypted message including the user's mobile phone number, PIN, MID, the PID, and the PDD (step 604). The message may be decoded (step 606), and an attempt to authenticate the user based, at least in part, on the user's mobile phone number and PIN is made (step 608). An evaluation may then be made to determine if the user was successfully authenticated (step 610). In the event that the user was not successfully authenticated, the Mobile Payment System processing routine may send a failure notification to the merchant POS (step 612), and the Mobile Payment System processing routine cycle may then end (step 628).

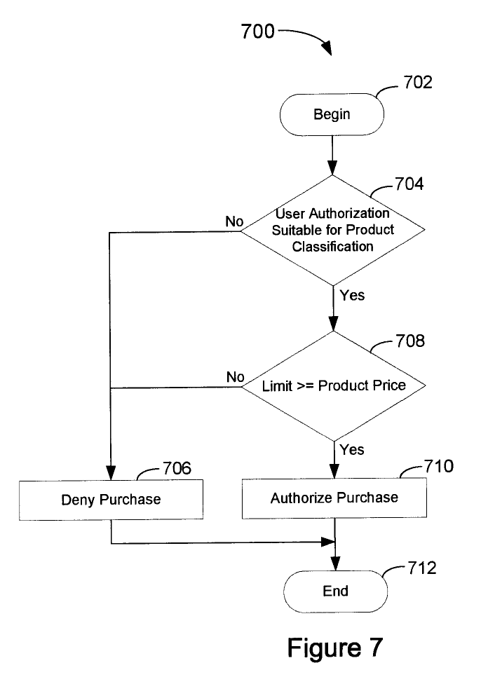

Returning again to step 610, if the user is successfully authenticated, the Mobile Payment System processing routine may query the user record to obtain an authorization level (step 614). Retrieval of the authorization level may include a purchase limit assigned to the user. An evaluation may then be made to determine if the user is authorized to purchase the product (step 616) as described more fully hereinbelow with reference to FIG. 7. If the user is not authorized to purchase the product, a failure notification may be sent from the Mobile Payment System to the merchant POS according to step 612). If the user is authorized to purchase the product at step 616, an encryption key may be generated by the Mobile Payment System (step 618), and the encryption key may be transmitted to the merchant POS (step 620). An OTP may be generated (step 622) and encrypted thereby, and the encrypted OTP may then be sent to the merchant POS (step 624). An SMS message request including the OTP may be originated by the Mobile Payment System that is addressed to the user mobile phone number (step 626). For example, a request for an SMS message that includes the OTP and the user mobile phone number may be generated and transmitted from the Mobile Payment System to an SMS provider. The Mobile Payment System processing routine cycle may then end according to step 628.

FIG. 7 is a flowchart 700 that depicts processing of a mobile purchase authorization subroutine implemented in accordance with an embodiment. The processing steps depicted in FIG. 7 are an example embodiment of a subroutine that may be implemented for performing the user authorization evaluation described with reference to step 616 of FIG. 6. The processing steps of FIG. 7 may be implemented as computer-executable instructions executable by a processing system, such as Mobile Payment System 140 depicted in FIGS. 1 and 2.

The authorization subroutine is invoked (step 702), and the user authorization level may then be compared with the PID classification to determine if the user authorization level is suitable for purchasing the product (step 704). If the user authorization level is insufficient for the PID classification, the purchase may be denied (step 706), and the authorization subroutine cycle may then end (step 712).

Returning again to step 704, if the user authorization level is sufficient for the PID classification, the authorization subroutine may then evaluate the user purchase limit to determine if the purchase limit equals or exceeds the product purchase price (step 708). If the purchase limit is insufficient for the product purchase price, the authorization subroutine may deny the purchase according to step 706. If it is determined that the purchase limit equals or exceeds the product purchase price, the authorization subroutine may then authorize purchase of the product (step 710), and the authorization subroutine cycle may then end according to step 712.

As described, a user operating a mobile terminal may submit a product for purchase at a POS. A product ID is obtained by the POS, and a product price may additionally be obtained by the POS. The user may then enter the user's phone number and PIN at the POS. An authentication and authorization process is then performed to authenticate the user and authorize the transaction. In an embodiment, the POS generates an encrypted message that is transmitted to a Mobile Payment System for user authentication and purchase authorization. The encrypted message includes the user's mobile phone number and PIN, as well as the product ID. On receipt of the encrypted message, the Mobile Payment System may authenticate the user, e.g., via the user's phone number and PIN. If the user is successfully authenticated, the purchase request may be evaluated to determine if the user is authorized to purchase the product. In one implementation, a classification of the product may be evaluated to determine if a user authorization level is sufficient for purchasing the product. Furthermore, a purchase limit assigned to the user may be evaluated to determine if the user has a sufficient purchase limit for the product. If the user is authenticated and authorized successfully, a one-time-password is generated by the Mobile Payment System 140. The one-time-password may then be encrypted and transmitted to the POS along with an encryption key. On receipt of the encrypted message and the key, the POS may decrypt the message to obtain the one-time-password. Additionally, an SMS request may be transmitted from the Mobile Payment System to an SMS provider. The SMS request may include the user's mobile phone number and the one-time-password. The SMS provider then generates an SMS message that is addressed to the user's mobile phone number and that includes the one-time-password. An SMS message including the one-time-password is then transmitted from the SMS service provider to the user's mobile phone. On receipt of the SMS message, the user may read the one-time-password and provide the one-time-password as input to the POS. The POS 110 may then compare the one-time-password provided by Mobile Payment System with the one-time-password provided by the user. If the one-time-passwords match, the purchase may be completed, and a receipt for the product may be issued. If the one-time-passwords do not match, the purchase may be denied by the POS.

In accordance with a particular embodiment, multiple user's may be associated with a common account. Each user may have a distinct identifier, such as a personal identification number, that is used to authenticate a particular user of the account. The personal identification number may be used in conjunction with a mobile phone number associated with the particular account user. Each of the plurality of users of a common account may have different authorization levels assigned thereto. For instance, an adult that is responsible for the account subscription may have an adult authorization designation, while children or other users of the account may have different authorization levels. Assignment of different authorization levels to users of a common account facilitates purchase restrictions, e.g., age-based product restrictions, as well as account spending limits that may be different for different account users.

The flowchart of FIGS. 5-7 depict process serialization to facilitate an understanding of disclosed embodiments and are not necessarily indicative of serialization of the operations being performed. In various embodiments, the processing steps described in FIGS. 5-7 may be performed in varying order, and one or more depicted steps may be performed in parallel with other steps. Additionally, execution of some processing steps of FIGS. 5-7 may be excluded without departing from embodiments disclosed herein.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single computer processor or multiple computer processors. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure.

What is claimed is:

1. A method of electronic commerce, comprising:
maintaining authentication information of a user in association with purchase authorization information of the user, wherein authentication and authorization information of a plurality of users is maintained in association with a common subscriber account;
receiving an identifier of a product to be purchased at a remote location by the user;
performing an authentication of the user based on input supplied by the user;
performing an authorization evaluation of whether the user is authorized to purchase the product based on the authorization information; and
accepting or denying purchase of the product based on at least one of results of the authentication and results of the authorization.

2. The method of claim 1, wherein maintaining authentication information comprises maintaining at least one of a mobile phone number assigned to a mobile terminal of the user and a personal identification number of the user.

3. The method of claim 1, wherein receiving an identifier of a product further comprises receiving a universal product code of the product from a merchant point-of-sale terminal.

4. The method of claim 1, wherein performing an authentication of the user based on input supplied by the user further comprises comparing at least one of a mobile phone number and a personal identification number supplied by the user at a merchant point-of-sale terminal with at least one of a mobile phone number and a personal identification number associated with the user maintained by a network-based mobile payment system.

5. The method of claim 1, wherein performing an authorization evaluation further comprises comparing an authorization level associated with the user with a classification of the product.

6. The method of claim 1, wherein performing an authorization evaluation further comprises comparing a purchase limit associated with the user with a price of the product.

7. The method of claim 1, further comprising:
generating a one-time-password;
encrypting the one-time-password;
transmitting the one-time-password in an encrypted format to a merchant point-of-sale terminal at which the user initiated purchase of the product; and
transmitting the one-time-password to a mobile phone of the user.

8. The method of claim 7, further comprising:
supplying, by the user, the one-time-password to the merchant point-of-sale terminal;
decrypting the one-time-password received in the encrypted format by the merchant point-of-sale terminal;
performing a comparison the decrypted one-time-password with the one-time-password supplied by the user; and
determining an approval or rejection of the purchase based on results of the comparison.

9. A computer-readable medium having computer-executable instructions for execution by a processing system, the computer-executable instructions for electronic commerce, comprising:
instructions for maintaining authentication information of a user in association with purchase authorization information of the user, wherein authentication and authorization information of a plurality of users is maintained in association with a common subscriber account;
instructions for receiving an identifier of a product to be purchased at a remote location by the user;
instructions for performing an authentication of the user based on input supplied by the user;
instructions for performing an authorization evaluation of whether the user is authorized to purchase the product based on the authorization information; and
instructions for accepting or denying purchase of the product based on at least one of results of the authentication and results of the authorization.

10. The computer-readable medium of claim 9, wherein the instructions for maintaining authentication information comprise instructions for maintaining at least one of a mobile phone number assigned to a mobile terminal of the user and a personal identification number of the user.

11. The computer-readable medium of claim 9, wherein the instructions for receiving an identifier of a product further comprise instructions for receiving a universal product code of the product from a merchant point-of-sale terminal.

12. The computer-readable medium of claim 9, wherein the instructions for performing an authentication of the user based on input supplied by the user further comprise instructions for comparing at least one of a mobile phone number and a personal identification number supplied by the user at a merchant point-of-sale terminal with at least one of a mobile phone number and a personal identification number associated with the user maintained by a network-based mobile payment system.

13. The computer-readable medium of claim 9, wherein the instructions for performing an authorization evaluation further comprise instructions for comparing an authorization level associated with the user with a classification of the product.

14. The computer-readable medium of claim 9, wherein the instructions for performing an authorization evaluation further comprise instructions for comparing a purchase limit associated with the user with a price of the product.

15. The computer-readable medium of claim 9, further comprising:
instructions for generating a one-time-password;
instructions for encrypting the one-time-password;
instructions for transmitting the one-time-password in an encrypted format to a merchant point-of-sale terminal at which the user initiated purchase of the product; and
instructions for transmitting the one-time-password to a mobile phone of the user.

16. The computer-readable medium of claim 15, further comprising:
instructions for supplying, by the user, the one-time-password to the merchant point-of-sale terminal;
instructions for decrypting the one-time-password received in the encrypted format by the merchant point-of-sale terminal;
instructions for performing a comparison the decrypted one-time-password with the one-time-password supplied by the user; and
instructions for determining an approval or rejection of the purchase based on results of the comparison.

17. A system for performing electronic commerce, comprising:
a mobile terminal assigned to a user having a mobile phone number assigned thereto;
a merchant point-of-sale terminal adapted to receive a product identifier of a product to be purchased by the user, the phone number of the mobile terminal of the user, and a personal identification number of the user, wherein the point-of-sale terminal is adapted to determine a product description and generate a message including the phone number, the personal identification number, the product identifier, and the product description; and
a mobile payment system communicatively coupled with the merchant point-of-sale terminal and adapted to receive the message, wherein the mobile payment system is adapted to authenticate the user and authorize the purchase based at least in part on one of the phone number, the personal identification number and the product identifier, and wherein the mobile payment system is adapted to transmit a one-time-password in an encrypted format to the point-of-sale terminal;
a messaging network communicatively coupled with the mobile payment system, wherein the messaging network receives a request from the mobile payment system to transmit the one-time-password to the mobile terminal, wherein the point-of-sale terminal is adapted to receive the one-time-password received by the mobile terminal from the user and determine whether to accept or deny the purchase based on the one-time-password received by the mobile terminal and the one-time-password transmitted to the point-of-sale terminal from the mobile payment system.

18. The system of claim 17, wherein the messaging network comprises a mobile carrier network including a short message service infrastructure.

19. The system of claim 17, further comprising a user database that maintains a record assigned to the user, wherein the record includes the phone number, the personal identification number, and an authorization level assigned to the user.

20. The system of claim 17, wherein the product description comprises at least one of a product classification and a product price, and wherein mobile payment system is adapted to determine an authorization level associated with the user and determine whether the user is authorized to purchase the product based on the authorization level and the product classification.
